(19) United States
(12) Patent Application Publication
(10) Pub. No.: US 2010/0013619 A1
(43) Pub. Date: Jan. 21, 2010

(54) SENSOR ASSEMBLY

(75) Inventor: Claes ZIMMER, Trollhättan (SE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/504,622

(22) Filed: Jul. 16, 2009

(30) Foreign Application Priority Data
Jul. 18, 2008 (GB) 0813162.5

(51) Int. Cl. B60Q 1/00; G08B 17/12

(52) U.S. Cl. 340/449; 340/600; 340/459

(57) ABSTRACT

A sensor module is provided for use in a passenger compartment of a motor vehicle that includes, but is not limited to a circuit board, at least one passenger compartment temperature sensor, and at least one solar irradiation detection sensor. The sensor module further includes, but is not limited to at least one ambient light detection sensor and at least one content theft deterrent device. A motor vehicle is also provided with such a sensor module.

### CROSS-REFERENCE TO RELATED APPLICATION

This application claims priority to British Patent Application No. 0813162.5, filed Jul. 18, 2008, which is incorporated herein by reference in its entirety.

### TECHNICAL FIELD

The present invention relates to a sensor module for use in a passenger compartment of a motor vehicle which comprises a circuit board, at least one passenger compartment temperature sensor and at least one solar irradiation detection sensor.

### BACKGROUND

Sensor modules of the aforementioned type are known as such in the prior art. Such sensor modules are usually mounted in the middle of an instrument panel of the vehicle adjacent to a front windshield. Sensor modules of the known type are used for detecting passenger compartment temperatures and for detecting incident solar irradiation. Those sensor modules are therefore used for the control of air condition devices which take into account the amount of incident solar irradiation.

Sensor modules of the known type are for example disclosed in EP 0 949 096 B1. This document discloses a motor vehicle incorporating a heating and ventilation or air conditioning system with at least one sun sensor and at least one temperature sensor which are arranged in only one common sensor housing in the interior of the motor vehicle. The temperature sensor serves as the only interior temperature sensor for detecting the temperature in the interior of the motor vehicle.

This motor vehicle has the drawback that modern vehicles comprise a higher degree of comfort features such as automatically activation of driving lights in dawn or in tunnels or the like. Further, many vehicles comprise alarm equipment for deterring theft of valuable articles in the interior of the vehicle or of the vehicle itself. Those devices have to be located separately in the motor vehicle in prior art.

Further, DE 102 56 001 A1 discloses a motor vehicle incorporating a heating and ventilation or air conditioning system comprising at least one sun sensor and a humidity sensor. The sensor further comprises a housing which is arranged on an instrument panel close to a windscreen. The aforementioned motor vehicle comprises the same drawbacks as the aforementioned. The necessary separate arrangement of multiple sensor equipment in different locations of the passenger compartment of a motor vehicle is cost intensive and raises development effort.

Further modern vehicles comprise multiple equipment options so that differently equipped vehicles may not need some of the aforementioned sensors. Different types of interior panels have to be developed for such different equipment variants.

At least one object of the invention is therefore to provide a sensor module which significantly reduces engineering effort and reduces the necessity of multiple different compartment modules. In addition, other objects, desirable features, and characteristics will become apparent from the subsequent summary and detailed description, and the appended claims, taken in conjunction with the accompanying drawings and this background.

### SUMMARY

The at least one object, other objects, desirable features, and characteristics are provided by means of a sensor module designed for use in a passenger compartment of a motor vehicle and comprises a circuit board, at least one passenger compartment temperature sensor and at least one solar irradiation detection sensor. The at least one passenger compartment temperature sensor is used for detecting the inner temperature of the passenger compartment. This information is usually fed to a control system of an air conditioning device of said motor vehicle. The solar irradiation detection sensor is used for detection of the intensity, elevation and azimuth of the incident solar irradiation, which also has the effect on passengers that they seize this immediately as a higher temperature. Modern air conditioning systems are developed to take this effect into account.

The inventive sensor module is usually designed to be arranged on an instrument panel of the vehicle, usually close to a front windscreen.

A motor vehicle may be any kind of vehicle with motor independent of the motor concept. Therefore, the invention is also referring to electro-driven vehicles, fuel cell vehicles or the like.

The sensor module further comprises at least one ambient light detection sensor and at least one content theft deterrent device.

The ambient light detection sensor is used for detection of the brightness of the surroundings for automatic activation or deactivation of driving lights if the brightness of the ambient light significantly changes. Such ambient light detection sensors are very useful for suddenly changing brightness (e.g., while driving into a tunnel or the like).

The at least one content theft deterrent means is able to signalize the presence and readiness of an alarm system with which the motor vehicle may be equipped. The content theft deterrent means helps preventing burglary of valuable articles in the interior of the motor vehicle and/or theft of the vehicle itself. Such content theft deterring means may also be included in vehicles without alarm equipment for pretending to be equipped with such. The content theft deterring devices are preferably positioned such that they can be easily recognized from the outside of said motor vehicle.

The sensor module according to an embodiment of the invention is therefore highly integrated and significantly reduces development effort for vehicles with different equipment. Today, air conditioning devices are nearly standard in motor vehicles of every class. Therefore, such sensor modules have to be equipped as standard. Further, the usual arrangement of the sensor module in the middle of an instrument panel adjacent to a windscreen is ideal for the arrangement of said content theft deterrent means.

According to a first preferred embodiment the content theft deterrent means is provided by lightning means, especially one or more LEDs. Lightning means have the advantage of being easily recognizable from the outside of the motor vehicle. LEDs have proved to be energy saving and combine longevity with compact dimensions.

A further preferred embodiment includes a housing for the sensor module which is at least partially transparent for visible light. The transparency may be provided by a special screen or by the use of housings with high transparency in the visible spectrum of electromagnetic waves. Further, the housing does not need to be completely transparent so that it may have a dark outer shading. This improves safety, because a dark housing does not reflect in the windscreen and therefore does not disturb the driver. Partial transparency may be compensated via calibration of the system.

Further, it has shown advantages for the housing to be at least partially transparent for infrared light or to comprise a hole adjacent to the passenger compartment temperature sensor. According to the respective construction of the passenger compartment temperature sensor, the passenger compartment temperature sensor may use the amount of infrared light or may measure the temperature of the air of the passenger compartment. In case of a hole adjacent to the passenger compartment it has shown sufficient to provide one or two holes such that the hole or holes enable for a constant exchange of air in the area of the passenger compartment temperature sensor.

A further advantageous embodiment refers to a sensor module which further comprises control means for alternately activation of the content theft deterrent means and the ambient light detection sensor. Such control means prohibit influence of the content theft deterrent means on the ambient light detection sensor in case of optical content theft deterrent means.

Usually, the content theft deterrent means are only activated while the respective motor vehicle is switched off and/or locked and therefore not in use but there may be cases in which an ambient light detection sensor and the content theft deterrent means are activated at the same time (e.g., after switching off the vehicle and after leaving and closing the vehicle in darkness). Often, the lighting of the car is activated in dark surroundings to increase convenience of the passengers. With the use of said control means an influence of said content theft deterrent means on the ambient light detection sensor can be prevented.

Advantageously, the sensor module comprises at least two solar irradiation detection sensors which are separated by a wall. The at least two solar irradiation detection sensors are used to determine the direction of the incident sun. The wall which separates the at least two solar irradiation detection sensors leads to an angle-dependent intensity distribution on the at least two solar irradiation detection sensor which is used to determine a coefficient from the intensity detected by each solar irradiation detection sensor which is dependent on the direction of incident radiation.

It is further shown to be advantageous to integrate said wall in said circuit board such that it is protruding from the circuit board. This reduces the complexity of the assembly of the sensor module.

A further advantageous embodiment of the sensor module comprises control means for activation of the content theft deterrent means when the vehicle is switched off and/or locked. It is also possible to combine this embodiment with the aforementioned embodiment. Content theft deterrent means are usually needed when the vehicle is not in use. Advantageously, the at least one passenger compartment temperature sensor and/or the at least one solar irradiation detection sensor and/or the at least on ambient light detection sensor and/or the at least one content theft deterrent means are arranged on the circuit board of the sensor module. This reduces assembly efforts because of the higher degree of integration and because of the possibility of pre-factoring of the circuit board. Furthermore, the arrangement of at least some of the sensors on the circuit board leads to a reduction of material (e.g., cables or the like), which helps making the sensor module even cheaper.

A further preferred embodiment of the invention relates to a sensor module with a specific mounting direction in the vehicle which may be provided by appropriate connection means. The circuit board, which is usually a flat panel, is arranged with its narrow sides towards a driving direction and towards a vertical axis of the vehicle in mounted position of the sensor module. Therefore, the broad sides of the sensor circuit board are arranged perpendicular to a driving direction of the car and to a vertical axis. The circuit board itself may be tilted in a plane which is defined as before such that it's narrow sides may have components towards or against driving direction and towards a vertical axis with respect to each narrow side. Therefore, the circuit board is arranged in mounted position as a wall extending in driving direction. The arrangement of the circuit board establishes multiple possibilities of arrangement of the different sensors of the sensor module. Further up, to the upstanding circuit board the mounting area of the circuit board is increased because both broad sides of the circuit board may be used for equipment with sensor module components.

A further preferred embodiment relates to a sensor module which comprises at least two ambient light detection sensors and/or at least to solar irradiation detection sensors and/or at least two solar irradiation detection sensors are mounted on opposite sides of the circuit board. This increases the ability of directional determination of ambient light and/or sun light.

It has further shown advantageous to provide three solar irradiation detection sensors which are arranged on the circuit board. Two of the solar irradiation detection sensors are arranged on one side of said circuit board and are separated by a wall protruding from the circuit board, wherein the remaining solar irradiation detection sensor is arranged on the opposite side of the circuit board. This arrangement improves the capability of the sensor module to determine the direction of the incident solar irradiation. The second sensor on the side with two sensors may be used to determine solar irradiation from the backside of the car.

Advantageously, two of the three solar irradiation detection sensors are mounted mirror symmetrically with respect to the plane of the broad side of the circuit board. This increases the capability of detection of the direction of incident sun light.

It has further shown to be advantageous to arrange the content theft deterrent means in a rear area with respect to a driving direction of the vehicle in the case of a specific mounting direction of the sensor module in the vehicle. This increases the space for the other sensor equipment in the front area of the sensor module.

A first independent embodiment of the invention relates to a motor vehicle comprising such a sensor module. Preferably, the sensor module is arranged in an instrument panel of the respective vehicle. Preferably, the sensor module is arranged in a middle area of said instrument panel near a windscreen of the vehicle.

### BRIEF DESCRIPTION OF THE DRAWINGS

The present invention will hereinafter be described in conjunction with the following drawing figures, wherein like numerals denote like elements, and:

FIG. 1 depicts a part of an instrument panel of a motor vehicle comprising a sensor module;

FIG. 2 shows a perspective view of a sensor element;

FIG. 3 shows a perspective view of a sensor element without housing;

FIG. 4 shows a perspective view of said sensor element without housing from another angle; and

FIG. 5 shows a top view on the sensor element.

### DETAILED DESCRIPTION

The following detailed description is merely exemplary in nature and is not intended to limit application and uses. Furthermore, there is no intention to be bound by any theory presented in the preceding background and summary or the following detailed description.

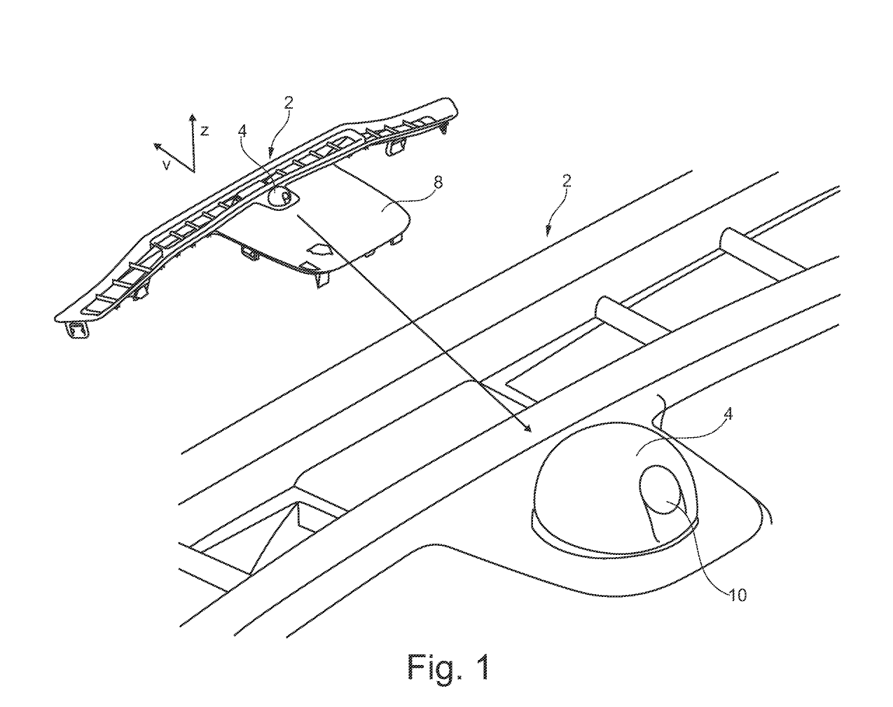

FIG. 1 shows a part of an instrument panel 2 of a motor vehicle comprising a sensor module 4 according to an embodiment of the invention. The sensor module 4 is arranged in a middle area of the instrument panel 2 in the neighborhood of a windscreen 6 of the vehicle. The sensor module 4 is partially integrated into the instrument panel 2 so that only a top part of the sensor module 4 reaches out of the instrument panel 2. The sensor module 4 may be arranged in the area of a front center speaker cover 8 or a defrost grille outlet.

The sensor module 4 comprises an area 10 which is partially transparent for light which is irradiated by integrated content theft deterrent means which are not visible in FIG. 1. Especially in case of the use of an LED as a content theft deterrent means said transparent area 10 may be designed as being transparent for a specific wavelength only.

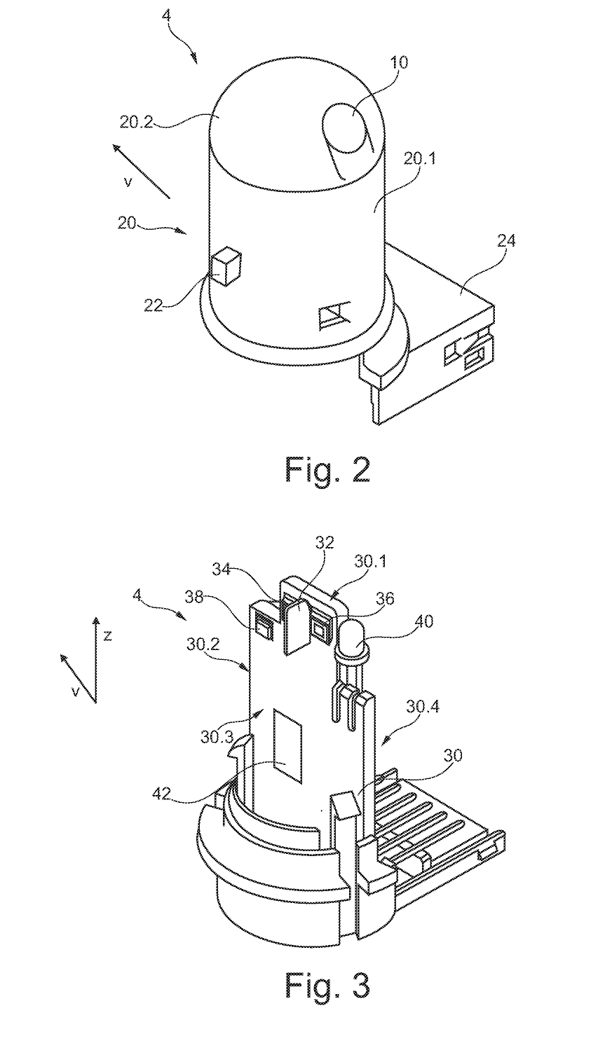

With reference to FIG. 2, the sensor module 4 is depicted separately. The sensor module 4 comprises a housing 20 which has a basically cylindrical shaped area 20.1 and a basically spherical shaped area 20.2. The basically cylindrical area 20.1 will be invisibly arranged below a surface of said instrument panel 2.

According to a driving direction V, the transparent area 10 for the content theft deterrent means is arranged on the backside of said sensor module 4. The sensor module 4 further comprises mounting means 22 and a connector 24 for connecting the sensor module 4 with the vehicle electrical system.

With reference to FIG. 3, the sensor module 4 is shown without housing 20.

A circuit board 30 is arranged standing upright in the sensor module 4. Narrow sides 30.1, 30.2 are arranged in driving direction V and towards a vertical axis Z of the vehicle. Broad sides 30.3, 30.4 are arranged perpendicular to V and Z. A wall 32 is arranged protruding from said circuit board 30.

Solar irradiation detection sensors 34, 36 are arranged on said circuit board 30 on either side of the wall 32. Further, an ambient light detection sensor 38 is arranged on the circuit board 30. At least, a content theft deterrent LED 40 is arranged on the circuit board 30. The content theft deterrent LED 40 is arranged in a rear area of said sensor module 4.

The ambient light detecting sensors 38, 46 may be realized by phototransistors which are capable for detection of visible light. The solar irradiation detection sensors 34, 36, 44 may be set up as photodiodes which are capable of registration of near infrared.

Further control means 42 are arranged on said circuit board 30.

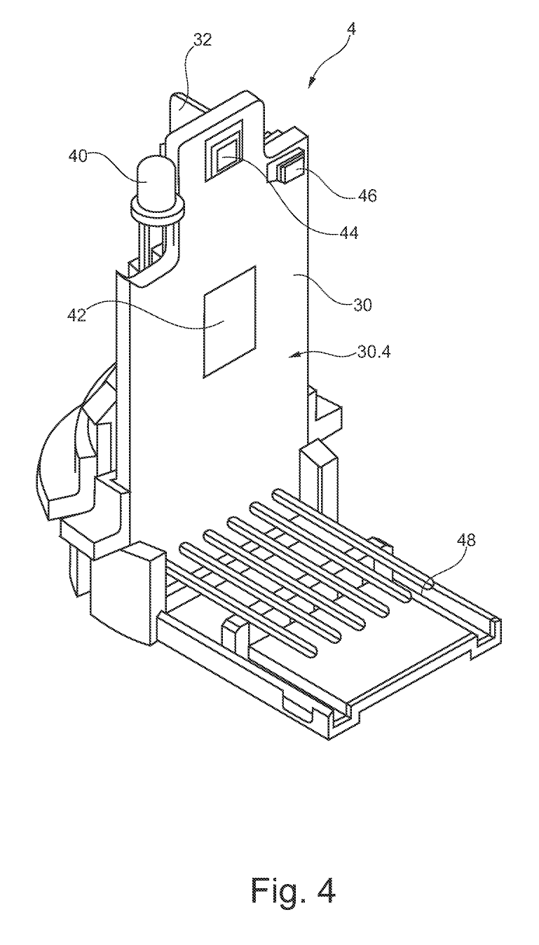

On the other side of the circuit board shown in FIG. 4, a further solar irradiation detection sensor 44 is arranged on the circuit board 30. Also, a further ambient light detection sensor 46 is arranged on the other side of the circuit board 30 shown in FIG. 4.

The shown side 30.4 of the circuit board 30 also comprises parts of the control means 42. The control means 42 enable the sensor module 4 to alternately activate the content theft deterrent LED 40 and the ambient light detection sensors 38, 46. Further the control means 42 enable activation of the content theft deterrent LED 40 when the vehicle is switched off and/or locked.

In the lower part of said circuit board 30 a passenger compartment temperature sensor 50 is arranged. The passenger compartment temperature sensor 50 may be a temperature dependent resistor, especially a negative temperature coefficient thermistor, which is fed through a hole in said housing 20.

The broad side 30.4 further comprises connection means 48 for connecting the sensor module 4 with the electrical system of the motor vehicle.

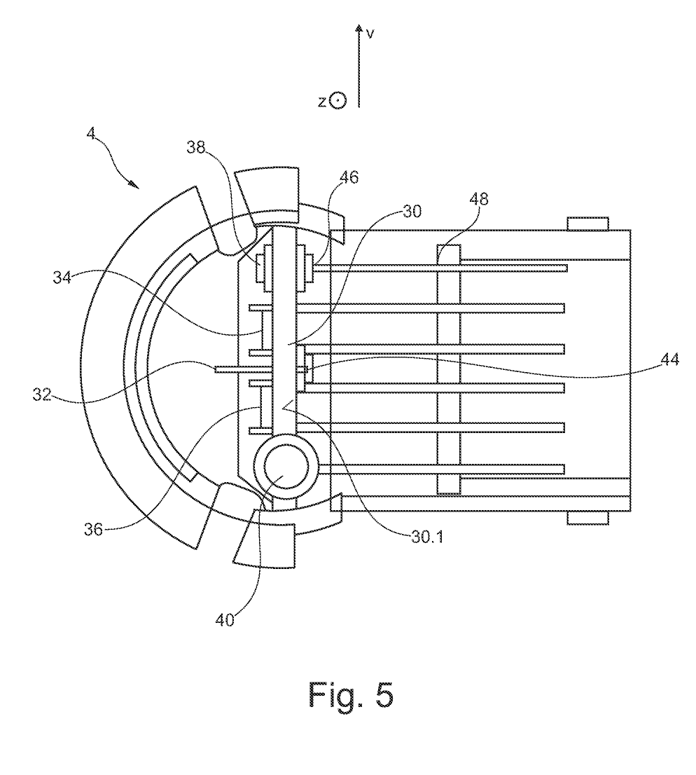

FIG. 5 shows a top view of said sensor module 4. The ambient light detection sensors 38, 46 are arranged at a front end of said circuit board 30 and the solar irradiation detection sensors 34, 36, 44 are arranged behind the ambient light detection sensors 38, 46. The content theft deterrent LED 40 is arranged at the backside of the circuit board 30.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A sensor module for use in a passenger compartment of a motor vehicle comprising:
a circuit board;
a passenger compartment temperature sensor;
a solar irradiation detection sensor; and
an ambient light detection sensor and a content theft deterrent device.

2. The sensor module according to claim 1, wherein the content theft deterrent device is a light emitter.

3. The sensor module according to claim 1, further comprises a housing that is at least partially transparent for visible light.

4. The sensor module according to claim 1, further comprising a housing that is at least partially transparent for infrared light.

5. The sensor module according to claim 1, further comprising at least two solar irradiation detection sensors that are separated by a wall.

6. The sensor module according to claim 5, wherein said wall is protruding from said circuit board.

7. The sensor module according to claim 1, further comprising a controller for alternately activating the content theft deterrent device and said ambient light detection sensor.

8. The sensor module according to claim 1, wherein said passenger compartment temperature sensor is arranged on said circuit board.

9. The sensor module according to any one of claim 7, wherein said sensor module is placed in a specific mounting direction in said motor vehicle and said circuit board is arranged with a narrow side toward a driving direction and a vertical axis of the motor vehicle in mounted position of said sensor module.

10. The sensor module according to claim 7, wherein said sensor module comprises at least two ambient light detection sensors, wherein said at least two ambient light detection sensors are mounted on opposite sides of said circuit board.

11. The sensor module according to claim 7, wherein three solar irradiation detection sensors are arranged on said circuit board, wherein two of said solar irradiation detection sensors are arranged on one broad side of said circuit board and separated by a wall protruding from said circuit board, wherein a remaining solar irradiation detection sensor is arranged on an opposite broad side of said circuit board.

12. The sensor module according to claim 1, wherein said sensor module has a specific mounting direction in said motor vehicle wherein said content theft deterrent device is arranged in a rear area with respect to a driving direction of said motor vehicle.
